(19) United States
(12) Patent Application Publication
(10) Pub. No.: US 2026/0051031 A1
(43) Pub. Date: Feb. 19, 2026

(54) SYSTEMS AND METHODS FOR MEDICAL IMAGES DENOISING USING DEEP LEARNING

(71) Applicant: Subtle Medical, Inc., Menlo Park, CA (US)

(72) Inventor: Ludovic SIBILLE, Rosny-sur-Seine (FR)

(21) Appl. No.: 19/367,505

(22) Filed: Oct. 23, 2025

Related U.S. Application Data
(63) Continuation of application No. PCT/US2024/025655, filed on Apr. 22, 2024.
(60) Provisional application No. 63/497,830, filed on Apr. 24, 2023.

(51) Int. Cl. G06T 5/60; G06T 5/70

(52) U.S. Cl. CPC G06T 5/60; G06T 5/70; G06T 2207/10104; G06T 2207/20081; G06T 2207/20084; G06T 2207/30004

(57) ABSTRACT

Methods and systems are provided for data augmentation. The method comprises: acquiring an input image data and metadata, wherein the metadata relates to information about an image quality; training a conditional diffusion model based on the input image data and the metadata; and using the conditional diffusion model to predict a synthesized low-quality image based on an input high-quality image and corresponding metadata.

### CROSS-REFERENCE TO RELATED APPLICATION

This application is a continuation of International Application No. PCT/US2024/025655 filed on Apr. 22, 2024, which claims priority to U.S. Provisional Application No. 63/497,830 filed on Apr. 24, 2023, the content of which is incorporated herein in its entirety.

### BACKGROUND

Machine learning or deep learning has been employed in medical imaging to improve image quality. For instance, low-quality image or degraded image such as images acquired with reduced dose of contrast agent, accelerated acquisition, or acquired under standard conditions but degraded due to other reasons may be improved by applying a deep learning model to predict synthesized image with improved image quality. A challenge for machine learning in medical imaging comprises obtaining sufficient high-quality labelled data or paired dataset for training the model. Training effective deep learning models may require large quantities of labelled data. For example, to train a denoising model, the training dataset may comprise relatively lower quality image data and corresponding higher quality image data (i.e., ground truth data). Currently, data augmentation may be utilized to generate low quality image that is simulated from corresponding high quality image. For example, simulation model may be applied to raw image data (image data from clinical database) to transform it to low quality image data to create artifacts. However, simulation tools such as Monte Carlo simulation tools (e.g., GATE) which are traditionally used to model various scanner designs and detector materials can be time consuming. The simulation times can be in the order of days to weeks for a single simulation to generate sufficient simulated training dataset while realistic anthropomorphic simulation of tracer uptake has yet to be demonstrated. Further, it is challenging for such traditional simulation tools to replicate all the simulation parameters to match the acquired data and/or it is difficult for simulation parameters to capture all different types of artifacts, noise, and the like in the acquired real data.

### SUMMARY

As described above, current methods to denoise low dose PET images may rely on paired training images (e.g., low dose/full dose image, normal/accelerated scanned image, etc.) which are difficult and expensive to collect. The present disclosure provides improved imaging systems and methods that can address various drawbacks of conventional systems, including those recognized above. Methods and systems as described herein can provide an improved noise generator that is developed to generate realistic synthetic low-quality image. In particular, methods herein may conditionally model a noise generator based on paired images (e.g., high/low quality image, full/low dose image, normal/accelerated scanned image, etc.) and metadata to generate synthetic low-quality image. The synthetic low-quality image generated by the noise generator may then be utilized to train a denoising model for improving image quality. In some embodiments, the noise generator may comprise a diffusion model conditioned on metadata. In some cases, the diffusion model may take as input a high-quality image data (e.g., full dose image) and metadata and output a synthetic low-quality image data (e.g., low dose image). In some cases, the image data in the input has an image quality higher than an image quality of the output image data.

The methods herein may provide an improved noise generator or diffusion model by conditionally modelling the noise generator based on paired images (e.g., high/low quality image) as well as metadata. For example, the training data pairs may comprise image with higher quality along with respective metadata paired with ground truth image which has lower quality. Conditioning the diffusion model on additional metadata may beneficially simulate various types of artifacts in the acquired data such as realistic anthropomorphic simulation of tracer uptake and/or reduce simulation time. For example, Positron Emission Tomography (PET) has demonstrated a clear clinical value in the management of cancer patients. Patients who undertake PET for treatment are injected with a large dose of radioactive tracer such as 18F-FDG or Gadolinium-Based Contrast Agents (GBCAs) into tissues or organs before scanning. This process generates radiation exposure, which may be harmful to patients, especially in patients who need multiple examinations or pediatric patients with a higher lifetime risk for developing cancer. Although lowering the dose of radioactive tracer can reduce radiation exposure, it also yields increased noise, artifacts, and a lack of imaging details. The noise generator herein may be developed based on metadata that is related to image quality. For instance, image quality of positron emission tomography depends on the number of counts of radioactive decay acquired by the scanner. The number of counts in a region depends on the total administered activity, scanner sensitivity, image acquisition duration, radiopharmaceutical tracer uptake in the region, and patient local body morphometry surrounding the region. Metadata associated with such image quality information (e.g., radiopharmaceutical injected, dose of the low dose image, dose of the full dose image, manufacturer, scanner model, image acquisition duration) may be extracted and utilized as condition to train the noise generator.

Once the noise generator or diffusion model is developed, it may be used to generate synthetic low-quality image. The synthetic low-quality images can be utilized for various purposes such as data augment or utilized as training data to train a model (e.g., denoise model) for improving image quality. For example, the denoise model may be a supervised or self-supervised based image enhancement system that can improve the image quality of an initial degraded image due to accelerated acquisition, reduced contrast agent dose, lower radiation dose, different radiopharmaceutical rejection, different scanning model/protocol and the like.

In an aspect of the present disclosure, a method for training a diffusion model is provided. The method comprises: obtaining a first image having a first image quality and a corresponding second image having a second image quality, where the first image quality is higher than the second image quality; generating training data comprising the first image, the second image and a metadata comprising information about the first image and the second image; and training a diffusion model based on the training data and optimizing parameters of a diffusion model to simulate an artifact in the second image.

In a related yet separate aspect, a non-transitory computer-readable medium comprising machine-executable code that, upon execution by a computer, implements a method for training a diffusion model. The method comprises: obtaining a first image having a first image quality and a corresponding second image having a second image quality, where the first image quality is higher than the second image quality; generating training data comprising the first image, the second image and a metadata comprising information about the first image and the second image; and training a diffusion model based on the training data and optimizing parameters of a diffusion model to simulate an artifact in the second image.

In some embodiments, the metadata comprises the information about a scanning apparatus for acquiring the first image and the second image, an image acquisition process, a dosage of contrast agent administered for acquiring the first image and the second image, or radiopharmaceutical injection.

In some embodiments, generating the training data comprises generating a metadata embedding encoding the information. In some cases, the training data comprises an embedding encoding the metadata and time associated with the first image or the second image. In some instances, the diffusion model is a U-Net model comprising one or more downsampling blocks and one or more upsampling blocks. For example, the embedding is fused with the first image or the second image in the one or more downsampling blocks or the one or more upsampling blocks.

In some embodiments, the method further comprises during an inference stage, supplying an input comprising an input high-quality image and a corresponding metadata to the diffusion model trained in (c) and outputting a synthesized low-quality image. In some cases, the input high-quality image is a 2.5D stack of slices. In some instances, the method further comprises chunking the 2.5D stack of slices into a plurality of chunks. For example, the method further comprises randomly sampling an overlapping volume of two consecutive output chunks to aggregate a plurality of output chunks to form the synthesized low-quality image.

As utilized herein, “low quality” image herein may refer to degraded image which may comprise images acquired with reduced dose of contrast agent, accelerated acquisition, or acquired under standard conditions but degraded due to other reasons. Examples of low quality in medical imaging may include a variety of artifacts, such as noise (e.g., low signal noise ratio), blur (e.g., motion artifact), shading (e.g., blockage or interference with sensing), missing information (e.g., missing pixels or voxels in painting due to removal of information or masking), reconstruction (e.g., degradation in the measurement domain), and/or under-sampling artifacts (e.g., under-sampling due to compressed sensing, aliasing).

The noise generator may be capable of simulating low quality images with various artifacts or various noise distributions without acquiring extra simulation time. The simulated low-quality images may then be utilized to train an image enhancement capable of generating an image with higher image quality.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and descriptions are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an exemplary method of generating synthetic low-quality image using a diffusion model.

FIG. 2 shows an example of chunk aggregation method.

FIG. 3 shows an exemplary method of generating input embedding for the metadata.

FIG. 4 shows an exemplary network architecture for generating a synthetic low-quality image data (e.g., chunk).

FIG. 5 shows an example of down-sampling and up-sampling blocks in a U-net architecture.

FIG. 6 and FIG. 7 shows example of results generated by the methods herein.

FIG. 8 schematically shows a method of using the noise generator for data augmentation.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Deep learning has been employed to improve image quality. However, current methods to enhance image quality such as denoising low dose PET images may rely on paired training images (e.g., low dose/full dose image, normal/accelerated scanned image, etc.) which are difficult and expensive to collect. The present disclosure provides an improved noise generator that is developed to generate realistic synthetic low-quality image. In particular, methods herein may conditionally model a noise generator based on paired images (e.g., high/low quality image, full/low dose image, normal/accelerated scanned image, etc.) and metadata to generate synthetic low-quality image. The synthetic low-quality image generated by the noise generator may then be utilized to train a denoising model for improving image quality. In some embodiments, the noise generator may comprise a diffusion model conditioned on metadata. In some cases, the diffusion model may take as input a high-quality image data (e.g., full dose image) and metadata and output a synthetic low-quality image data (e.g., low dose image).

The methods herein may provide an improved noise generator or diffusion model by conditionally modelling the noise generator based on paired images (e.g., high/low quality image) as well as metadata. Conditioning the diffusion model on additional metadata may beneficially simulate various types of artifacts in the acquired data such as realistic anthropomorphic simulation of tracer uptake and/or reduce simulation time. For example, Positron Emission Tomography (PET) has demonstrated a clear clinical value in the management of cancer patients. Patients who undertake PET for treatment are injected with a large dose of radioactive tracer such as 18F-FDG or Gadolinium-Based Contrast Agents (GBCAs) into tissues or organs before scanning. This process generates radiation exposure, which may be harmful to patients, especially in patients who need multiple examinations or pediatric patients with a higher lifetime risk for developing cancer. Although lowering the dose of radioactive tracer can reduce radiation exposure, it also yields increased noise, artifacts, and a lack of imaging details. The noise generator herein may be developed based on metadata that is related to image quality. For instance, image quality of positron emission tomography depends on the number of counts of radioactive decay acquired by the scanner. The number of counts in a region depends on the total administered activity, scanner sensitivity, image acquisition duration, radiopharmaceutical tracer uptake in the region, and patient local body morphometry surrounding the region. Metadata associated with such image quality information (e.g., radiopharmaceutical injected, dose of the low dose image, dose of the full dose image, manufacturer, scanner model, image acquisition duration) may be extracted and utilized to train the noise generator.

Once the noise generator or diffusion model is developed, it may be used to generate synthetic low-quality image which can be further utilized as training data to train a model for improving image quality. For example, the model may be a supervised or self-supervised based image enhancement system that can improve the image quality of an initial degraded image due to accelerated acquisition, reduced contrast agent dose, lower radiation dose, different radiopharmaceutical rejection, different scanning model/protocol and the like.

Though positron emission tomography (PET) image, denoising examples are primarily provided herein, it should be understood that the present approach, models, methods and systems may be used in other imaging modality contexts or various other image restoration tasks. For instance, the presently described approach may be employed on data acquired by other types of tomographic scanners including, but not limited to, computed tomography (CT), single photon emission computed tomography (SPECT) scanners, magnetic resonance (MR) scanner, functional magnetic resonance imaging (fMRI) scanners and the like. Methods, systems and/or components of the systems or models may be used in other imaging tasks (e.g., super-resolution, image denoising, accelerated imaging, lower contrast agent dosage, etc.).

The term low quality image as utilized herein may refer to degraded image which may comprise images acquired with reduced dose of contrast agent, accelerated acquisition, lower resolution, or acquired under standard conditions but degraded due to other reasons. Examples of low quality in medical imaging may include a variety of artifacts, such as noise (e.g., low signal noise ratio), blur (e.g., motion artifact), shading (e.g., blockage or interference with sensing), missing information (e.g., missing pixels or voxels in painting due to removal of information or masking), reconstruction (e.g., degradation in the measurement domain), under-sampling artifacts (e.g., under-sampling due to compressed sensing, aliasing), and/or other artifacts (e.g., image corruption).

The noise generator may be capable of simulating low quality images with various artifacts or various noise distributions without acquiring extra simulation time. The simulated low-quality images may then be utilized to train an image enhancement capable of generating an image with higher image quality.

### Conditional Denoising Diffusion Model

In some embodiments, systems and methods herein may provide a noise generator. The noise generator may take as input a high-quality image data (e.g., full dose image) and metadata and output a synthetic low-quality image data (e.g., low dose image). In some embodiments, the noise generator may be created by randomly sampling (low dose, full dose) from training data to fit a diffusion model conditioned on the metadata. The diffusion model may also be referred to as conditional Denoising Diffusion Probabilistic Model (DDPM) which are utilized interchangeably throughout the specification.

A diffusion probabilistic model (“diffusion model”) is a parameterized Markov chain trained using variational inference to produce samples matching the data after finite time. Given a dataset of input-output image pairs, denoted

$$D = {\{ {x}_{i} , {y}_{i} \}}_{i = 1}^{N}$$

which represent samples drawn from an unknown conditional distribution ρ(x V y), the methods herein may learn a parametric approximation to the conditional distribution ρ(x V y) using a conditional Denoising Diffusion Probabilistic Model (DDPM). The pair of images xᵢ, yᵢ may represent a source image x (high quality image) and a corresponding low-quality image (e.g., target noisy image) as the ground truth. The source image may comprise an image with higher quality along with metadata related to an acquisition process of the image and/or the low-quality image. In some cases, the metadata may comprise information about an acquisition process or quality of both the high-quality image and low-quality image. The training data may comprise the paired high-quality image and low-quality image, along with the metadata. The conditional DDPM model generates a target image x₀ in T refinement steps. The DDPM model iteratively refines the image through successive iterations (x_{T-1}, x_{T-2}, . . . , x₀) according to learned conditional transition distributions ρ_{ϕ}(xₜ₋₁ V xₜ, y) such that x₀ is a sample from ρ(x V y).

### Forward Diffusion Process

The method may define a forward Markovian diffusion process q that gradually adds Gaussian noise to a high-quality (e.g., high-resolution image) x₀ over T iterations:

$$q ( {x}_{1 : T} ∨ {x}_{0} ) = {\prod }_{t = 1}^{T} q ( {x}_{t} ∨ {x}_{t - 1} )$$

$$q ( {x}_{t} ∨ {x}_{t - 1} ) = N ( {x}_{t} ; \sqrt{1 - {β}_{t}} {x}_{t - 1} , {β}_{t} I )$$

where the scalar parameters β_{1:T} are hyper-parameters, subject to 0<βₜ<1, which determines the variance of the noise added at each iteration. The value of βₜ controls the amount of noise to add on timestamp t. The term q(xₜ V xₜ₋₁) denotes the probability density function for a single step from imagexₜ to xₜ₋₁ in the forward diffusion process.

Importantly, one can characterize the distribution of xₜ given x₀ by marginalizing out the intermediate steps as:

$$q ( {x}_{t} ∨ {x}_{0} ) = N ( {x}_{t} ; \sqrt{\underline{{α}_{t}}} {x}_{0} , ( 1 - \underline{{α}_{t}} ) I )$$

$$Where {α}_{t} = 1 - {β}_{t} and = {\prod }_{t = 1}^{T} {α}_{t}$$

Next, a neural network is trained to reverse or simulate a reversion of the Gaussian diffusion process.

### Optimizing the Reverse Diffusion

To guide the reversing the diffusion process, the method takes additional metadata information (e.g., as radiopharmaceutical injected, dose of the low dose image, dose of the full dose image, manufacturer, scanner model, image acquisition duration, etc.) and optimize a neural denoising model ϵ_{θ} that takes as input this source image x and a noisy target image y. The neural denoising model ϵ_{θ} may be trained by optimizing the parameters of the model with the following loss function:

$${L}_{simple} ( Φ ) = {E}_{t , {y}_{0} , x , ϵ} {\vert ϵ - {ϵ}_{0} ( \sqrt{} {x}_{0} + \sqrt{1 - \underline{{α}_{t}}} ϵ , t , y ) \vert}^{2}$$

Sampling from the DDPM

The sampling process may start the inference from t=T and noise z=N(0, I)

$${x}_{T} = N ( 0 , I )$$

$${x}_{t - 1} = \frac{1}{\sqrt{{α}_{t}}} ( {x}_{t} - \frac{1 - {α}_{t}}{\sqrt{1 - {α}_{t}}} {ϵ}_{Θ} ( {x}_{t} , t , y ) ) + {σ}_{t} z$$

The sampling procedure of diffusion models is a type of progressive decoding that resembles autoregressive decoding along a bit ordering that vastly generalizes what is normally possible with autoregressive models. The sampling procedure resembles Langevin dynamics with the neural denoising model ϵ_{θ} as learned gradient of the data density.

### Methods to Simulate Low-Quality Image Using Diffusion Model

As described above, the noise generator is trained by randomly sampling (e.g., low dose image, full dose image) from the training data to fit a diffusion model (i.e., conditional DDPM). The conditional DDPM can take as input the high-quality image (e.g., full dose image or image acquired with full dose of contrast agent) and metadata and output the synthetic low-quality image (e.g., low dose image).

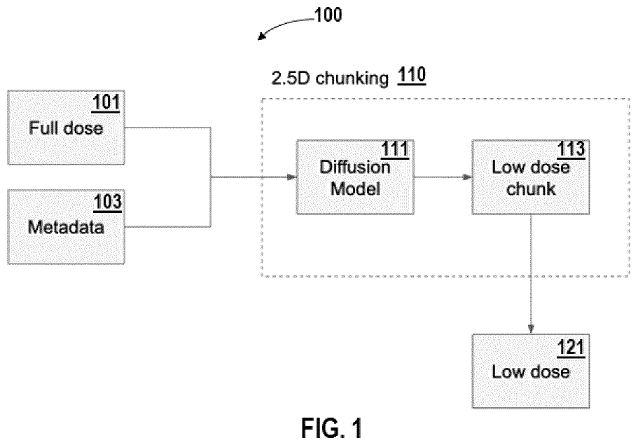

FIG. 1 shows an exemplary method 100 of generating synthetic low-quality image using a diffusion model. In FIG. 1, the input comprises high-quality image (e.g., full dose image) 101 and metadata 103 and the output 121 comprises low-quality image (e.g., low dose image). In the illustrated example, the high-quality image 101 may include Positron Emission Tomography (PET) image acquired with full dose of contrast agent. Positron Emission Tomography (PET) has demonstrated a clear clinical value in the management of cancer patients. Patients who undertake PET for treatment are injected with a large dose of radioactive tracer into tissues or organs before scanning. This process generates radiation exposure, which may be harmful to patients, especially in patients who need multiple examinations or pediatric patients with a higher lifetime risk for developing cancer. Although lowering the dose of radioactive tracer can reduce radiation exposure, it also yields increased noise, artifacts, and a lack of imaging details. To be able to reduce the dose of radioactive tracer, deep learning models may be utilized to enhance the input image quality. However, as mentioned above training such models may require large volume of paired images. The methods herein may utilize a conditional diffusion model 111 to generate a synthetic low dose image 121

The conditional diffusion model 111 can be created and developed as described elsewhere herein. Once the diffusion model 111 is developed, it may be fed with input data including the full dose image 101 and metadata 103 then output of corresponding low dose image.

In some embodiments, the method 100 may employ a unique chunk aggregation technique to reduce memory usage. The chunking 110 and chunk aggregation method provided herein may process 3D volumes or 2.5D images in chunks in a dynamic manner so that the processing can fit with any given hardware constraints such as memory constraints. In some cases, the diffusion model may operate in a 2.5D fashion (e.g., stack of image slices) wherein the input high quality image 101 may include a series of slices and the output of the diffusion model 111 may include the corresponding series of slices 113. The input stack of slices may be processed independently in one or more chunks. For example, the diffusion model 111 may process a pre-determined number of slices (e.g., 13 transverse slices) and output a corresponding number of synthetic low dose slices (e.g., 13 synthetic low dose slices). The transverse orientation fits with the PET image acquisition. The input image slices can be acquired in any other suitable orientation depending on the imaging modality, protocol and/or imaging set up. After all the low-dose chunks are generated, these chunks may be aggregated to form a synthetic low dose image with full image size 121 (e.g., 2.5D stack of image slices).

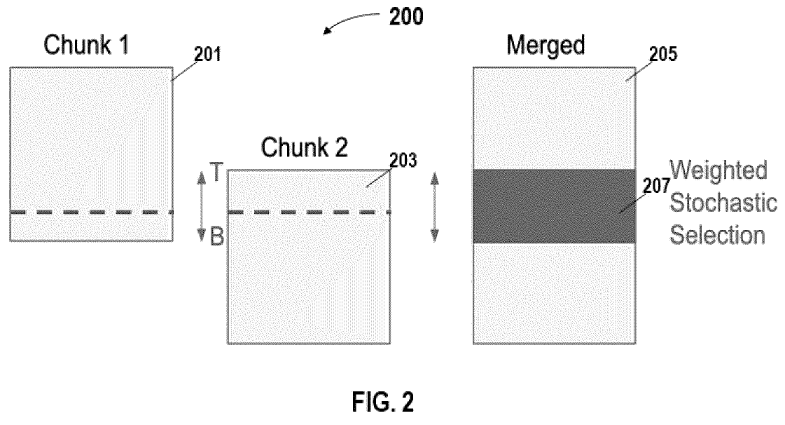

FIG. 2 shows an example of a chunk aggregation method 200. In some cases, the method may chunk the input high-quality volumetric image (e.g., full dose image) according to the hardware/memory constraints. For example, the size of a chunk such as the number of slices in a chunk may be determined based at least in part on the memory or hardware constraints. However, conventional chunking methods typically generate chunks with overlapped region to avoid boundary effects by averaging the chunk overlaps. Such overlapping region between chunks can be problematic for the noise generator or diffusion model since the noise would incur blurring.

The chunking and chunk aggregation method herein may beneficially address the above issue by randomly selecting voxel in the overlapping region or overlapping volume. In some cases, a voxel in an overlapping region may be randomly selected based on relative distance of the chunk overlap. For example, as illustrated in FIG. 2, two consecutive chunks i.e., chunk 1 201 and chunk 2 203 may have an overlapping region 207. In order to aggregate the chunks to form a final output image 205, a voxel in the overlapping region may be randomly selected based on a weighted Stochastic selection. For instance, the selection may be based on relative distance of the chunk overlap. For example, the probability of sampling a voxel from chunk 1 at position T is 1 and position B is 0. Conversely, the probability of sampling a voxel from chunk 2 at position T is 0 and position B is 1. During the aggregation, for a given slice t within the overlapping region (T, B), the probability that a particular voxel on slice t is sampled from Chunk 1 is defined as 1−(t−T)/(B−T), where T and B represent different depths in the stack.

It should be noted that the chunking and chunk aggregation method as described above are for illustration purpose only. Depending on the different input image types (e.g., 2D, 2.5D, 3D volume) and the like, various other different methods such as patching in 2D may be employed.

### Model Architecture

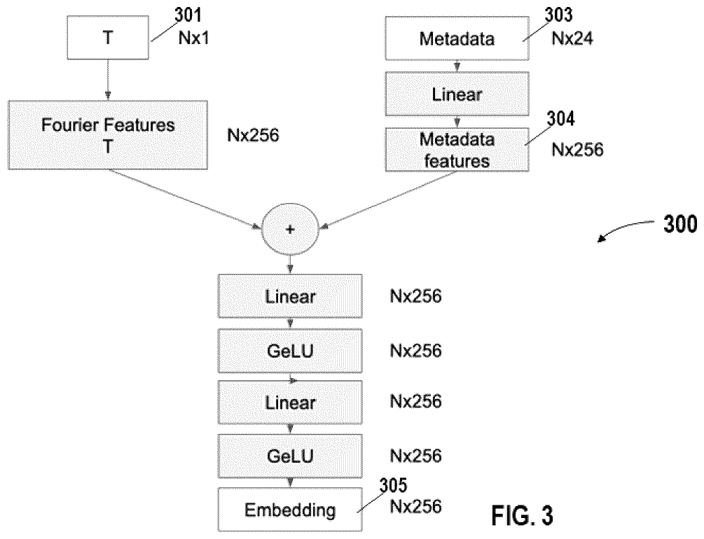

FIGS. 3-5 schematically show the model architecture for the diffusion model. FIG. 3 shows an exemplary method 300 of generating input embedding for the metadata to the diffusion model (referred to as conditional DDPM). The input may comprise an embedding 305 that is created based on the metadata 303 and the time embedding 301 (encoding timestamps of the image data). In some embodiments, Fourier Features method may be utilized to address the issue when inputs are high dimensional points (e.g., the pixels of an image reshaped into a vector) and training examples are sparsely distributed. A Fourier feature mapping of input coordinates makes the composed neural tangent kernel stationary (shift-invariant), acting as a convolution kernel over the input domain. In the illustrated example, a time embedding (e.g., N×1) is created based on Fourier Features, and an embedding for the metadata is created (e.g., N×24). The Fourier Features of the time embedding 301 and the metadata features 304 may have the same dimension (e.g., N×256 with N representing the batch size or chunk size as described above). Next the Fourier Features of the time embedding and the metadata features 304 may be processed to generate an output embedding 305 i.e., the (time, metadata) embedding, of the same dimension (e.g., N×256).

The metadata embedding may encode metadata information as described above. For example, information such as radiopharmaceutical injected, dose of the low dose image (i.e. low-quality image), dose of the full dose image (i.e., high-quality image), manufacturer, scanner model, image acquisition duration and the like may be encoded as metadata embedding. Any suitable encoding method can be adopted. For example, one-hot encoding may be utilized where index 0 of the metadata embedding represents whether the scan is from a Siemens machine (e.g., encoding[0]=1 if it is Siemens scanner, else 0). It should be noted that the dimension of the (time, metadata) embedding may be based on the dimension of the input image data (256×256). Any suitable size or dimension can be employed to encode the metadata as a vector.

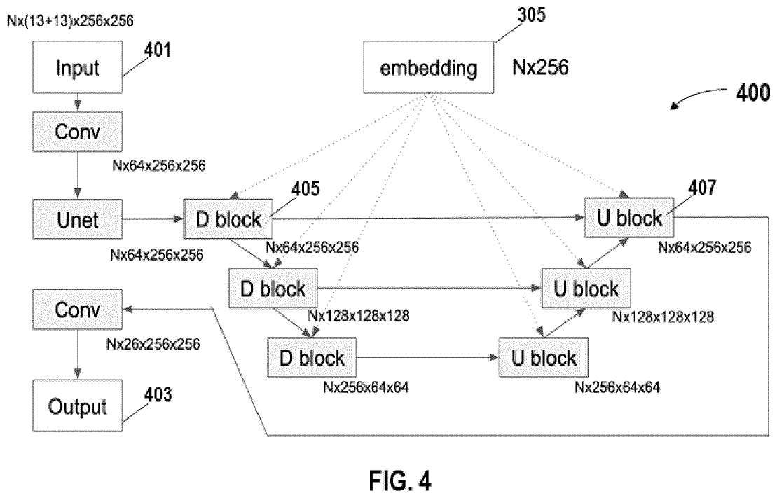

FIG. 4 shows an exemplary network architecture 400 for generating a synthetic low-quality image data (e.g., chunk). In the illustrated example, the model may comprise a standard encoder-decoder of the U-Net model with custom upsampling and downsampling blocks and skip connections. The method may condition layers on t by adding in the embedding 315 (e.g., (time, metadata) embedding) in the downsampling blocks 405 and upsampling blocks 407. The input 401 to the model 400 may comprise the current noisy input image xₜ concatenated withy (paired target noise image). As an example, the input image may be chunk of series of slices (e.g., number of 13 slices in the dimension of 256×256). The output 403 may comprise output chunk corresponding to the input chunk. It should be noted that the batch size (e.g., chunk size or number of slices) or dimension (e.g., 256×256) is for illustration purpose only. The size or dimension may be dependent on the raw image size, hardware/memory constraints as described else wherein herein.

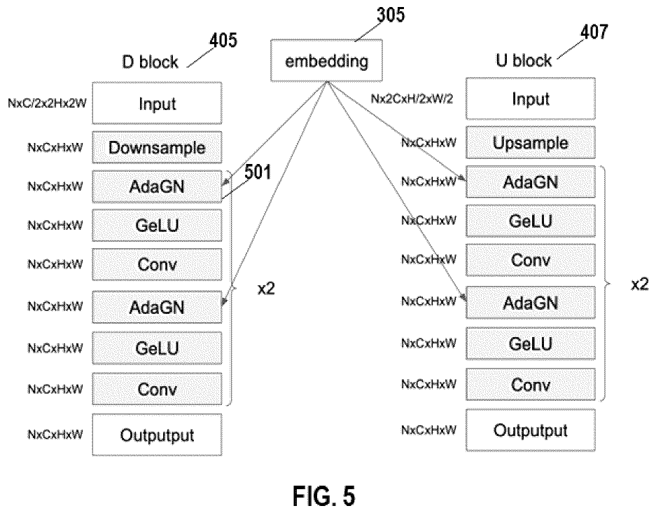

The network model may comprise unique Downsampling blocks (D block) and Upsampling blocks (U block). As shown in FIG. 5, inputs of the downsampling blocks 405 and/or upsampling blocks 407 may be modulated by the embedding 305 using a fusion layer or an adaptive group-wise Normalization (AdaGn) layer 501. The AdaGn layer may conduct normalization and modulation in a group level using the embedding 305. For instance, the AdaGn layer performs group-wise fusions that integrates the semantic group information (e.g., metadata information) into latent space and enables semantic disentangling for latent factors. It should be noted that other fusion method may be utilized to fuse the metadata embedding with the input image data.

During a training process, parameters of the model may be optimized using the loss function as described above. As an example, AdamW optimizer may be used with a learning rate (e.g., number of steps) and weight decay to train the model.

### Example Method and Experiments Results

Once the noise generator model or conditional DDPM is trained, it may be used for various purposes such as data augmentation to generate training data for a denoising model or other image enhancing model. For example, historical databases that only have a single full dose image can now be used during training of a denoising model. The noise generator may generate a synthetic low-dose image to form a training data pair with the full dose image. In some cases, the noise generator may be trained locally at the institution and exported. In some cases, the noise generator may be continuously trained upon receiving new data.

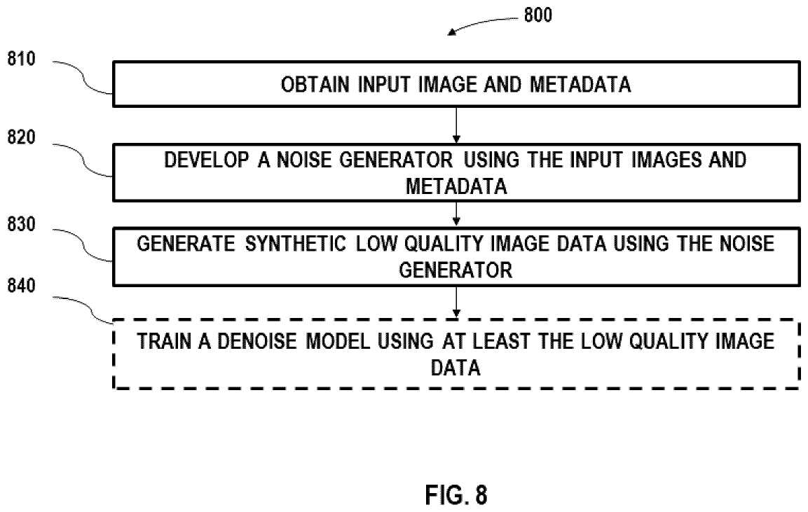

FIG. 8 schematically shows a method 800 of using the noise generator for data augmentation. As shown in the example, input image and metadata may be acquired 810. The input image data may comprise a pair of high-quality and low-quality image (e.g., full dose and reduced dose PET image). The metadata may comprise metadata information related to the image quality (e.g., radiopharmaceutical injected, dose of the low dose image, dose of the full dose image, manufacturer, scanner model, image acquisition duration and the like) as described elsewhere herein. The input image and metadata may be used to develop a noise generator 820. The noise generator may be created by randomly sampling (low dose, full dose) from the image data to fit a diffusion model conditioned on the metadata. The method and process for developing the diffusion model or the noise generator can be the same as those described above. For example, if the image is 2.5D volume image, chunk and aggregation may be employed to reduce memory requirement.

Once the noise generator is trained, it may be deployed to generate synthetic low-quality image 830. For example, during inference stage, the noise generator may take as input a high-quality image data (e.g., full dose image) and metadata and output a synthetic low-quality image data (e.g., low dose image). This may be used in data augmentation for training a denoise model 840. For example, training dataset for developing a denoise model may be augmented using the noise generator such that a low-quality image corresponding to a high-quality image may be synthesized and form a training pair.

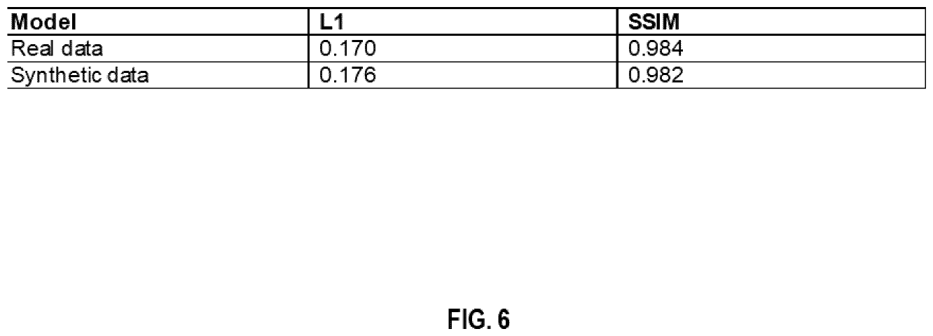

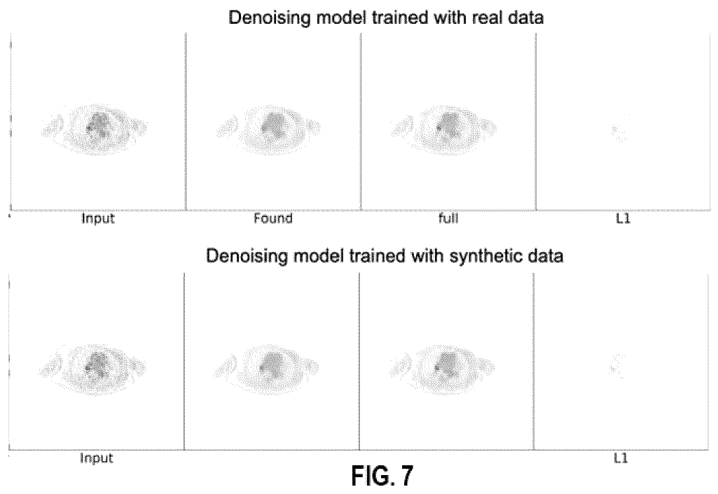

The methods and systems are implemented and validated on the Ultra Low dose dataset as shown in FIG. 6 and FIG. 7. A conditional DDPM model was trained using 220 patients with low dose fractions (0.5, 0.25, 0.1, 0.05, 0.01). To assess the faithfulness of the synthetic noising DDPM, two state of the art denoising models were trained: one used only the real data and the other used only synthetic data generated by the conditional DDPM. The two denoising models were assessed quantitatively with SSIM and L1 metrics on 30 independent patients. As shown in FIG. 6, denoising CNNs (convolutional neural networks) were trained for 700 epochs, the quantitative results are comparable. FIG. 7 shows an example of denoising output. The denoising output generated by a denoising model trained with real data is compared against denoising output generated by a denoising model trained on synthetic data. The results show that the synthetic data has accurately simulated the real data and the performance of the two denoising models are similar.

The systems and methods can be implemented on existing imaging systems or various other imaging modalities without a need of a change of hardware infrastructure. Alternatively, the systems and methods can be implemented by any computing systems that may not be coupled to any imaging system. For instance, methods and systems herein may be implemented in a remote system, one or more computer servers, which can enable distributed computing, such as cloud computing.

The methods herein can be implemented using a computer system. The computer system can comprise a laptop computer, a desktop computer, a central server, distributed computing system, etc. The processor may be a hardware processor such as a central processing unit (CPU), a graphic processing unit (GPU), a general-purpose processing unit, which can be a single core or multi core processor, a plurality of processors for parallel processing, in the form of fine-grained spatial architectures such as a field programmable gate array (FPGA), an application-specific integrated circuit (ASIC), and/or one or more Advanced RISC Machine (ARM) processors. The processor can be any suitable integrated circuits, such as computing platforms or microprocessors, logic devices and the like. Although the disclosure is described with reference to a processor, other types of integrated circuits and logic devices are also applicable. The processors or machines may not be limited by the data operation capabilities. The processors or machines may perform 512 bit, 256 bit, 128 bit, 64 bit, 32 bit, or 16 bit data operations.

Systems and methods of the present disclosure may provide a noise generator that can be implemented in software, hardware, firmware, embedded hardware, standalone hardware, application specific-hardware, or any combination of these. The noise generator can be a standalone system that is separate from the imaging system or other software modules (e.g., denoising model or image enhancement software).

Methods as described herein can be implemented by way of machine (e.g., computer processor) executable code stored on an electronic storage location of the computer system, such as, for example, on the memory or electronic storage unit. The machine executable or machine readable code can be provided in the form of software. During use, the code can be executed by the processor. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein A and/or B encompasses one or more of A or B, and combinations thereof such as A and B. It will be understood that although the terms “first,” “second,” “third” etc. are used herein to describe various elements, components, regions and/or sections, these elements, components, regions and/or sections should not be limited by these terms. These terms are merely used to distinguish one element, component, region or section from another element, component, region or section. Thus, a first element, component, region or section discussed herein could be termed a second element, component, region or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Reference throughout this specification to “some embodiments,” or “an embodiment,” means that a particular feature, structure, or characteristic described in connection with the embodiment is included in at least one embodiment. Thus, the appearances of the phrase “in some embodiment,” or “in an embodiment,” in various places throughout this specification are not necessarily all referring to the same embodiment. Furthermore, the particular features, structures, or characteristics may be combined in any suitable manner in one or more embodiments

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer-implemented method for training a diffusion model comprising:
(a) obtaining a first image having a first image quality and a corresponding second image having a second image quality, wherein the first image quality is higher than the second image quality;
(b) generating training data comprising the first image, the second image and a metadata comprising information about the first image and the second image; and
(c) training a diffusion model based on the training data and optimizing parameters of the diffusion model to simulate an artifact in the second image.

2. The computer-implemented method of claim 1, wherein the metadata comprises the information about a scanning apparatus for acquiring the first image and the second image, an image acquisition process, a dosage of contrast agent administered for acquiring the first image and the second image, or radiopharmaceutical injection.

3. The computer-implemented method of claim 1, wherein generating the training data comprises generating a metadata embedding encoding the information.

4. The computer-implemented method of claim 3, wherein the training data comprises an embedding encoding the metadata and time associated with the first image or the second image.

5. The computer-implemented method of claim 4, wherein the diffusion model is a U-Net model comprising one or more downsampling blocks and one or more upsampling blocks.

6. The computer-implemented method of claim 5, wherein the embedding is fused with the first image or the second image in the one or more downsampling blocks or the one or more upsampling blocks.

7. The computer-implemented method of claim 1, further comprising during an inference stage, supplying an input comprising an input high-quality image and a corresponding metadata to the diffusion model trained in (c) and outputting a synthesized low-quality image.

8. The computer-implemented method of claim 7, wherein the input high-quality image is a 2.5D stack of slices.

9. The computer-implemented method of claim 8, further comprising chunking the 2.5D stack of slices into a plurality of chunks.

10. The computer-implemented method of claim 9, further comprising randomly sampling an overlapping volume of two consecutive output chunks to aggregate a plurality of output chunks to form the synthesized low-quality image.

11. A non-transitory computer-readable medium comprising machine-executable code that, upon execution by a computer, implements a method for training a diffusion model, the method comprising:
(a) obtaining a first image having a first image quality and a corresponding second image having a second image quality, wherein the first image quality is higher than the second image quality;
(b) generating training data comprising the first image, the second image and a metadata comprising information about the first image and the second image; and
(c) training a diffusion model based on the training data and optimizing parameters of the diffusion model to simulate an artifact in the second image.

12. The non-transitory computer-readable medium of claim 11, wherein the metadata comprises the information about a scanning apparatus for acquiring the first image or the second image, an image acquisition process, a dosage of contrast agent administered for acquiring the first image and the second image, or radiopharmaceutical injection.

13. The non-transitory computer-readable medium of claim 11, wherein generating the training data comprises generating a metadata embedding encoding the information.

14. The non-transitory computer-readable medium of claim 13, wherein the training data comprises an embedding encoding the metadata and time associated with the first image or the second image.

15. The non-transitory computer-readable medium of claim 14, wherein the diffusion model is a U-Net model comprising one or more downsampling blocks and one or more upsampling blocks.

16. The non-transitory computer-readable medium of claim 15, wherein the embedding is fused with the first image or the second image in the one or more downsampling blocks or the one or more upsampling blocks.

17. The non-transitory computer-readable medium of claim 11, further comprising during an inference stage, supplying an input comprising an input high-quality image and a corresponding metadata to the diffusion model trained in (c) and outputting a synthesized low-quality image.

18. The non-transitory computer-readable medium of claim 17, wherein the input high-quality image is a 2.5D stack of slices.

19. The non-transitory computer-readable medium of claim 18, further comprising chunking the 2.5D stack of slices into a plurality of chunks.

20. The non-transitory computer-readable medium of claim 19, further comprising randomly sampling an overlapping volume of two consecutive output chunks to aggregate a plurality of output chunks to form the synthesized low-quality image.
